(19) United States
(12) Patent Application Publication
(10) Pub. No.: US 2009/0200375 A1
(43) Pub. Date: Aug. 13, 2009

(54) METHOD AND SYSTEM FOR PREPARATION AND IMPLEMENTATION OF ELECTRONIC VOTING

(75) Inventors: Alexandr Albertovich Veshnyakov, Moscow (RU); Vladimir Alexeevich Kabanov, Moscow (RU); Vadim Viktorovich Yaschenko, Moscow (RU); Mikhail Alexandrovich Antselevich, Moscow (RU)

Correspondence Address: Locke Lord Bissell & Liddell LLP;Attn: IP Docketing, Three World Financial Center, New York, NY, 10281-2101, US

(73) Assignee: FEDERAL CENTER OF INFORMATIZATION AT THE CENTRAL ELECTION COMMISSION OF THE RUSSIAN FEDERATION, mASCOW (RU)

(21) Appl. No.: 11/913,405

(22) PCT Filed: Jul. 25, 2005
(86) PCT No.: PCT/RU05/00387

§ 371 Date: Mar. 19, 2009

(30) Foreign Application Priority Data
Jul. 15, 2005 (RU) 2005122453

(51) Int. Cl. G07C 13/00

(52) U.S. Cl. 235/386

(57) ABSTRACT

The invention discloses a method for preparation and implementation of electronic voting by means of an automated system according to the invention comprising a control terminal, an official person workstation at a voting precinct and terminals of voting places used for input, saving, display and output of information, creation of local databases in a dynamic mode, said databases comprising voting data blocks, data blocks of modes of functioning of the built-in terminals and devices including a voting device, as well an condition for access to the voting device, display devices and to devices for documenting the persons whose access right is identified by comparing their access codes sent to the automated system terminals with the access codes stored in a local memory. The system automatically tracks the performance of the devices, switches them according to the installed order of operations, while providing an access according to the established rules of operations, provides automatic processing of the voting process and the voting results, and forms protocols on the voting summary by an approved form in an authorized access mode. The documentation of the voting results and protocols is carried out on the same non-volatile carrier.

### FIELD OF THE INVENTION

This invention relates to information technologies and, more particularly, to methods providing automatic voting preparation and implementation procedure and summarizing the voting results when conducting election campaigns and referenda.

### BACKGROUND OF THE INVENTION

It is well known that the voting right is one of the basic principles of democracy guaranteeing involvement of citizens in political life at a country level and at national, regional and local levels and, therefore, the procedures used for voting preparation and implementation should be based on the principles of democratic elections and referenda.

The urgency of automation in the processes of operational and information support of the activity of organizational structures and citizens in preparation and implementation of various elections and referenda is obvious.

Information and communication technologies are used more and more in everyday life, and are also used for involvement of the population in the process of preparation and implementation of elections and referenda including learning people on the legal basis of everyday life and their rights, measures on strengthening the democratic base of the voting systems.

According to the Guidelines of the Council of Europe, when using the operational and information technologies for voting support and implementation, the voters should be provided with a possibility of voting not only at the polling place of their election district but also in other places and with other voting capabilities. In addition, maximum participation of all citizens having the voting right in elections should be supplemented with a possibility of participation in voting and referenda with an access to election process even if these are invalid voters and those who cannot be present physically at the polling place and to use the resources available. In so doing efficiency and reliability should be provided during the transfer of the voting results, as well as the information the course of preparation and implementation of voting, information the variants to be given to a voter for realization of his or her election including information the candidates.

In so doing it is necessary to prevent double voting by one voter with respect to one selection variant and only one voting channel with application of safe and reliable methods of summing up all voices and finding a correct result.

Besides, voting should be secret and organized so that at any stage of the voting procedure, in particular, at a stage of establishment of the voter identity to eliminate everything that could break the secret of the voter's will, and the count of votes should eliminate a possibility of establishment of any link between the vote cast and a concrete voter. Therefore, it is necessary that the expected number of cast votes in the bulletin reception device does not give a possibility of linking the result obtained with a concrete voter. Under conditions of a monitored environment the information the cast vote should be hidden as soon as the vote cast is over.

Besides, the system should provide availability and integrity of cast votes, as well as their confidentiality prior to the beginning of vote count. In so doing the data on the quantity of voices submitted for this or that election variant should not be available to the public until the moment of closing the voting.

During voting it is necessary to have a regularly updated accessible and complete electoral register and a list of participants of a referendum, as well as a list of candidates. The voter should have a possibility to check up the information about him in the electoral register. A mechanism of establishment of voter identity is thus necessary.

The voting bulletin should be authentic at all voting precincts, and the fact that the voice has been cast should be well documented.

In so doing for compatibility of the technical components used in the system equipped with components of different manufacturers, it is necessary to use common standards.

The legal acts regulating election or referendum should accurately define the time frames concerning all stages of the elections or referendum both prior and after thereof.

Much attention has been paid to the solution of this problem.

Known in the art are method and system including submission to a plurality of voters of displayed information according to the voting system comprising at least two selections, and each displayed image relates to one selection, a count of the quantity of images, automatic detection of relations of the cast votes, determination of the total relations of the cast votes (U.S. Pat. No. 6,739,508, B2)

Also known in the art is a voting system for voters at a place of their residence including an election campaign control computer submitting election data including one or more bulletins and a voter identifier, an integrated official person smart card configured by said computer, a smart card activation device and a voting machine which reads out the voter identification code from the smart card and the voter password, displaying at least one bulletin for voting to the identified voter (U.S. Pat. No. 6,550,675, B2). The system provides discussion with the voter about his/her selection variants and saving the discussion results after the voting.

Known in the art are voting method and system intended for independent checking of the bulletin, in which the voting is carried out using a voting computer station adapted for submission of a bulletin, reception of the voter's selection according to the bulletin, temporary saving the voter's selection, printing the voter's selection from the temporary storage, comparison of the printed election with the temporarily saved election by the voter, a decision of the voter on the election correctness, saving the final election results and direction of the bulletins with a selection for registration (U.S. Pat. No. 6,769,613, B2).

Known in the art is a voting method with usage of the electronic bulletins consisting in that before voting the members of the commission give to the subject of will expression an electronic device for identification to confirm the right to voting which is activated by a unique control device; in the ballot cabin the subject of will expression puts a card into the computer for activation of the voting program, the voting being carried out by depositing by the subject of will expression a preset form of a display image of an electronic bulletin on the computer touch screen of a selection sign in the field relating to the object of will expression to whose benefit the selection choice is made. Thus in the computer a record is made on the selection and the unique identification number is erased from said identification device, which is submitted to the commissions for organization of voting of other subjects of will expression, and the formed electronic bulletin image displaying a free choice of the subject, this subject prints this image on paper and drops the list into the sealed ballot box (RU, 2212056, C1).

Also known in the art is a voting system comprising a control computer producing data for the voting and including one or several voting bulletins, a portable storage medium for reception and saving of data from the control computer, a smart card activation device which obtains voting data stored on the portable storage medium and confabulates a smart card for voting, and at least one voting device for reception at least one bulletin with voting data from said carrier and reading the smart card configuration, said voting device displays at least one voting bulletin and submits selection for voting (US 2001/0035455, A1). Generally the system functions are as follows: data for new selections are produced in the computer by means of software, then the data are written onto carriers for bulletins and protocols which are then supplied to an electoral precinct (voting place) where these data are unloaded in a device for activation of smart cards and in a voting device; after that test voting may be effected for checking the working capacity of the program and correctness of the loaded voting data, then an election can be conducted using the device for generation of voting smart cards for testing and for active voting and the voting device for collection of voices. After the election is over, the data from the voting device are unloaded on the carriers, the carriers come back to the control computer where the election results are summed up and a poll record is formed. Testing and training voting may be carried out only prior to the beginning of the elections. The smart card of the employee of the electoral commission is used by this employee for the monitoring the operation of devices on the electoral precinct. However, in such a system the process of registration of the voter takes considerable time for copying the voting data on each voter's smart card and requires a considerable quantity of devices for activation of the smart cards. Besides, the digital data are transferred from the voting device to the control computer for compilation of protocols that creates a possibility of distortion of results or their loss. In so doing there is a considerable pause in the vote tabulation in the voting device and tally of votes at a managing place. In addition, there is a possibility of substitution of the voting subject and a subject using in future the same card for voting and for monitoring the operation of the control computer.

### DISCLOSURE OF THE INVENTION

An object of the present invention is to provide a method for preparation and implementation of voting and a device for realization of this method, in which the secret voting is secured and a possibility of definition of accessory of the made selection to the physical person or voting subject is excluded, and also to exclude a possibility of influence of any person, e.g. an official person on the process of voting performed by a subject of will expression. Another object is to give to the subject of will expression brief voting information sufficient for selection of an object.

Still another object of the invention is to develop a method for preparation and implementation of electronic voting, in which the access to creation of information given to the subject of will expression at the voting precinct, to the voting devices and to the tally of votes would be strictly regulated and inspected, and the results of the voting summary are documented while excluding any possibility of interference and distortion of the voting results. Another object is to develop a device allowing one to simplify the process of voting and summarizing as much as possible and also to provide automatic performance of operations, access to which should be prohibited during preset period of time or an access permitted for certain persons only.

These objects are attained by creating a method for preparation and implementation of electronic voting by means of electronic means for input, output, record, processing, imaging, saving, printing, documenting, reception and transfer of information and voting devices, including the following operations:

creation by an official person of a voting data block comprising at least:
information on the types of elections and the variants of objects of selection to be given to subjects of will expression on the ballot day at a voting precinct;
a list of key access codes of official persons to the process of input, recording, processing, displaying, saving, documenting, information transfer and drafting voting summary protocols at a voting precinct in a scope of the rights given thereto;
information on established access time given to the subjects of will expression at voting;
information on established access time to the voting device given to the official persons;
information allowing one to identify the subject who has generated said data block under the key access code given to him for performing said operation;
a key code identifying the access rights of an authorized official person to the voting device by each election conducted at a voting place,

saving the generated voting data block;

writing lists of physical persons—prospective subjects of will expression by each type of election for each voting precinct;

submission of said voting data block and said lists of physical persons to a forthcoming voting precinct;

development of means of identification of the access right of an official person at a voting precinct, submission of said identification means to said authorized official person;

development of means of identification of the access right of each prospective subject of will expression to voting by each type of elections comprising at least codes identifying a voting precinct, types of elections and a code of identification of access of the subject of will expression to voting;

development of said means of identification of the access right in an amount sufficient for identification of the voting access right for each of the supposed amount of prospective subjects of will expression on the ballot day at a voting precinct;

transfer of said plurality of means of identification of the access right of the subjects of will expression to a respective place of the forthcoming voting in a restricted access mode;

development of a voting precinct local database comprising said lists of physical persons—prospective subjects of will expression and said voting data block, said database being used by the official person whose scope of rights is confirmed by presenting the key code of the access right identification means corresponding to the key code stored in said voting data block;

checking the correspondence of the identification data given by the physical person with the data in said list of persons stored in the local database of a voting precinct;

registration of said physical person as a subject of will expression at the voting precinct,

submission to the subject of will expression of the access right identification means for voting comprising at least codes identifying a voting precinct and types of elections to be conducted at the voting precinct on the ballot day;

checking the competence of the subject of will expression to take part in the voting according to the type of election whose code is available in the access right identification means given to him;

exclusion by the official person of the subject of will expression from the access right identification means whose code of the type of election, in which the subject of will expression has no right to participate;

development by an official person at a voting precinct of a local database with means for identification of the access right given to the subjects of will expression by entering and saving the digital data contained in said identification means;

activation by the official person in said local database of the codes of the type of elections, the access to which of the subject of will expression is recognized competent by transferring such codes to the <<ready for voting>> mode;

allowing the subject of will expression to input the codes contained in the access right identification means given to him into the voting device under conditions of observance of voting secrecy;

in an automatic mode under conditions of locking the access for any person except for the subject of will expression within a time period established for voting;

checking the correspondence of the codes introduced by the subject of will expression in the voting device with the codes activated in said local database in the “ready for voting” mode;

submission to said subject of will expression of voting information comprising:
a list of types of elections, with respect to which the corresponding codes for said subject of will expression are activated in the local database;
information on a selected type of election in the voting precinct local database;
variants of selection objects in the type of elections chosen by him;
a proposal to the subject of will expression to confirm each selected object or to reject it, return to the beginning of the election and make a new selection;
transfer by the subject of will expression of the type of election code to the “voting is finished” mode;

in an automatic mode under conditions of locking the access for any person:
removal from the local database of the access right identification means of the subject of will expression who finished the voting;
continuous saving of the voting results of the subjects of will expression in the voting precinct local database and simultaneous continuous documentation of the voting process in a form acceptable for visual acquaintance,
termination of saving and documenting the voting results after a preset time of access given to the subjects of will expression for voting;
statistical processing of the voting results stored in the local database according to legislatively established parameters of forms of protocols on the voting summary for each of type of voting, saving the processing results in the voting precinct local database;
displaying in the voting device an image of a notice on approach of the time of access of the officials to the voting device;

in an automatic mode under conditions of locking the access for any person except for the official person who has confirmed his right of access input in the voting device of the access right identification means of the official person containing a key code identical to the key code saved in the voting precinct local database:
displaying the established forms of protocols on the voting summary by each type of elections and the results of the statistical processing of the voting results stored in the local database;
filling of the displayed forms of protocols with the indication in the protocol of the key code of the official person;
saving of the protocols in a digital form in the local database,
submission to an official person of voting summary protocols recorded on a non-volatile carrier in a form suitable for visual observation and fir sighing the protocols;
documenting the protocols on the voting summary suitable for visual observation a carrier containing the documented results of earlier voting of all subjects of will expression at the voting precinct;
providing a possibility of transfer the voting device to the <<election campaign is completed>> mode;
providing a possibility of removal from the device of the non-volatile carrier containing documentary information on continuous recording the voting results of all and each of the subjects of will expression and the voting summary protocols, archiving them in a form providing its safety and inaccessibility for unauthorized access or taking out.

In so doing, according to the invention, the access right identification means given to the subject of will expression may be selected in a random way from a set of such identification means submitted to the voting precinct by an official person and not used for access to the voting till the moment of registration of this subject of will expression.

Besides, according to the invention, the subject of will expression may be granted with an access right identification means containing codes identifying the voting precinct and the type of elections conducted on the ballot day at the voting precinct, the identification code providing access of the subject of will expression to voting generated by the official person directly at the voting precinct.

In addition, according to the invention, the subject of will expression may be granted with an access right identification means containing codes identifying the voting precinct and type of elections conducted on the ballot day at the voting precinct, in which case the access identification code can be generated by the subject of will expression himself directly in the voting device.

In this case, according to the invention, it is expedient that the access right identification code of the subject of will expression includes a unique random character string.

In so doing, according to the invention, each access right identification means may be placed on a suitable carrier with a possibility of read out and recognition.

Thus, according to the invention, the access right identification means can be placed on a carrier selected from the group including a smart card, a paper carrier, a plastic carrier and a magnetic medium.

In this case, according to the invention, the codes of the access right identification means may be made on an acceptable carrier in the form of a bar code.

In addition, according to the invention, continuous documentation of the voting results and voting summary protocols can be carried out at the voting precinct by printing their continuous image on a carrier having a size sufficient for writing all said results and protocols thereon.

In this case, according to the invention, the continuous printing can be carried out on a roll of a paper carrier.

The object of the invention is also achieved by using an automated system for realization of the method for preparation and implementation of electronic voting according to the invention, said system comprising:

a control terminal of an official person and at least one terminal of a workstation of the official person at the voting precinct interconnected through acceptable communication facilities and comprising at least:

an operational device of the terminal used for data input, reception, recording, processing, creation of data blocks and local databases comprising:
information on the types of elections conducted at voting precincts and on variants of selection objects,
a list of key codes and a scope of the access rights of the official persons at said terminals,
data on the access right identification means given to the subjects of will expression at the voting precinct,
installed modes of access to said terminals and access given to the subjects of will expression for voting,
operating conditions of said terminals,
lists of prospective subjects of will expression, who will vote at each election voting precinct,

a non-volatile storage device;

a display device used for visualization of the information sent to the local databases and taken from them, in a graphical, tabular and/or text form using a type of selection interface;

a data output device used for transmission of data blocks to the voting precinct database and their recording on a non-volatile carrier;

a device for creating access right identification means for the official person to the voting device or the subject of will expression at voting at any type of election comprising codes of identification of the access right to the information on a local database of a voting precinct with a possibility of input of these codes in the voting device, and creations of a local database of the access codes of the right identification means given to the subjects of will expression; and in so doing the workstation terminal of the official person at the voting precinct is protected from access by any person but the official person who makes a call to the terminal while submitting the key access code identifying him in a scope of rights given to him and identical to the key access code which is stored in the local database at the voting precinct;

voting place terminals connected to each other and to the workstation terminal of the official person at the voting precinct through a network controller comprising:
a voting device with a display means,
a device for processing the voting results,
a memory device, and in this case:

at least one of the voting place terminals at the voting precinct includes a device for documenting the voting process and results including the voting summary protocols,

a workstation terminal of an official person and voting place are connected to a network controller and providing functioning of the local databases in a continuous mode with a possibility of introducing by the official person, possessing such a right, restrictions to the access rights of the subject of will expression concerning the information from the local database at the voting precincts, and

the voting place terminals are used for performing the following operations:

in an automatic mode under conditions of blocking the access to the voting place terminal devices for any person but the subject of will expression within a preset access time:

input of the codes of the access right identification means submitted by the subject;

connection the access right identification means to a local database in a mode of call and checking the identity of the entered codes with the codes stored in the database of the given access right identification means of the subjects of will expression or an official person;

using information display means including an interface for visualization of the type of election and object selection variants for the subject of will expression with a possibility of controlling the image of the selected object for subsequent registration of the result of his voting or repeated voting,

transfer the code of the type of election to the <<election is completed>> mode;

in the automatic mode under conditions of locking the access for any person:

removal from the local database of the identification means access right codes of the subject who has completed the voting;

saving the voting results of the subject of will expression in the voting precinct local database;

continuous saving of the voting results of the subjects of will expression in the local database and simultaneous continuous documentation of the voting process and the voting results on a non-volatile carrier suitable for visual acquaintance,

termination of saving and documenting the voting results after a preset time of access given to the subjects of will expression for voting;

statistical processing of the voting results stored in the local database according to legislatively established parameters of forms of protocols on the voting summary for each of type of voting, saving the processing results in the voting precinct local database;

displaying in the voting device an image of a notice on approach of the time of access of the officials to the voting device;

in the automatic mode under conditions of blocking the access to the voting place terminal for any person but the official person after the time for such an access:

input of the codes of the access right identification means in the official person voting device;

connection of the access right identification means to the local database in an interrogation mode for checking the identity of the entered codes by the codes stored in the local database with access right identification means of the official person;

displaying the forms of protocols on the voting summary by each type of elections and the results of the statistical processing of the voting results which are stored in the local database;

providing a possibility of filling the displayed forms of protocols, signing the protocols with indication of a key code of the official person in the protocol;

saving the signed protocols in a digital form in the local database,

submission to the official person of the original of the voting summary protocols on an acceptable non-volatile carrier,

documentation of the voting summary protocols on a non-volatile carrier containing earlier documented results of voting of all subjects of will expression at the voting precinct in a form suitable for visual acquaintance,

display of the transfer of the voting device to the <<election campaign is completed>> mode,

providing a possibility of removal from the device of the non-volatile carrier containing continuous recording of an image of the documentary information on the voting results of all and each of the subjects of will expression and the voting summary protocols, their signing and archiving in a form providing its safety and inaccessibility for unauthorized access or its removal from the device.

In this case, according to the invention, the device for creating access right identification means can be used for generation of a code in the form of a unique random character string and its recording on the carrier of the access right identification means given to the subject.

In addition, according to the invention, the device for creating access right identification means can be used for allocation of each access right identification means on a non-volatile carrier with a possibility of read out.

In so doing, according to the invention, the device for creating access right identification means can be used for allocation of said means on a carrier from the group including a smart card, a paper carrier, a plastic carrier, and a magnetic medium.

In addition, according to the invention, the device for creating access right identification means can be used for disposing the codes of said means on an acceptable carrier in the form of a bar code.

In this case, according to the invention, the voting device can be used for input of the codes of the access right identification means by reading.

In addition, according to the invention, it is expedient that the device for creating access right identification means is adapted for creating means comprising codes identifying the voting precinct and the types of elections conducted on the ballot day at the voting precinct, whereas the voting device is adapted for producing a code identifying the right of access the subject of will expression to voting by input in the voting device of desirable characters and their saving in the voting precinct local database.

In this case, according to the invention, the voting device can be used for generation of a code in the form of a unique random character string and submission to the subject of will expression of such a sequence or its desirable part by his choice as a code of identification of the subject of will expression having the access right for voting.

In addition, according to the invention, the voting device may be provided with means for generating a sound signal in the event of the beginning of voting by the subject of will expression and termination of his voting.

In so doing, according to the invention, the voting place terminal may have an audio system for generating sound signals.

In this case, according to the invention, it is expedient that the documentation device is adapted for continuous documentation of the voting results including the voting summary protocols by way of continuous printing the data fed in the device on a carrier having a size sufficient for writing thereon all said results and protocols.

In this case, according to the invention, the documentation device can be used for continuous printing of data on a roll of a paper carrier.

In so doing, according to the invention, the system terminals can be used for transferring data and documents by means of acceptable switching and communication facilities.

In this case, according to the invention, it is reasonable that the voting device comprises:

an input device reading information from non-volatile memory cards by means of a card reader,

an information output and display unit,

a device for input of access codes by reading the codes from the carrier of the access right identification means and/or a device for input of access codes from a keyboard and/or a device for input of access codes by tactile contact with characters placed on the touch screen of a monitor screen and/or by means of saving in memory of a unique random character string generated in the voting device or its desirable part by choice of the subject of will expression.

In addition, according to the invention, it is desirable that the voting place terminal is made portable and adapted for offline work and transportation and has an independent power supply and a documentation device in the form of a printer used for printing on a continuous carrier.

### BRIEF DESCRIPTION OF THE DRAWINGS

The invention is further described by way of example of realization of the method of the voting preparation implementation according to the invention by means of an automated system, in which:

FIG. 1 is a block diagram of the automated system according to the invention with an illustration of information flows in the method of voting preparation and implementation according to the invention;

FIG. 2 is a scheme of a sequence of operations of the voting process in the voting device of the voting place terminal.

The given examples of realization of the invention do not cover all possible embodiments of realization of the invention and are not beyond the patent claims and do not limit a possibility of its application or modification.

### THE BEST EMBODIMENT OF REALIZATION OF THE INVENTION

The present invention may be illustrated by realization of the method of voting preparation and implementation according to the invention by means of an automated system according to the invention, for example, when conducting several election campaigns simultaneously. For example, elections of deputies of the State Duma of the Russian Federation, election of deputies to a municipal duma, election of a city mayor, and a territorial referendum. In so doing the voting precinct is used for voting simultaneously on all types of elections, and the subjects of will expression may participate in all these elections.

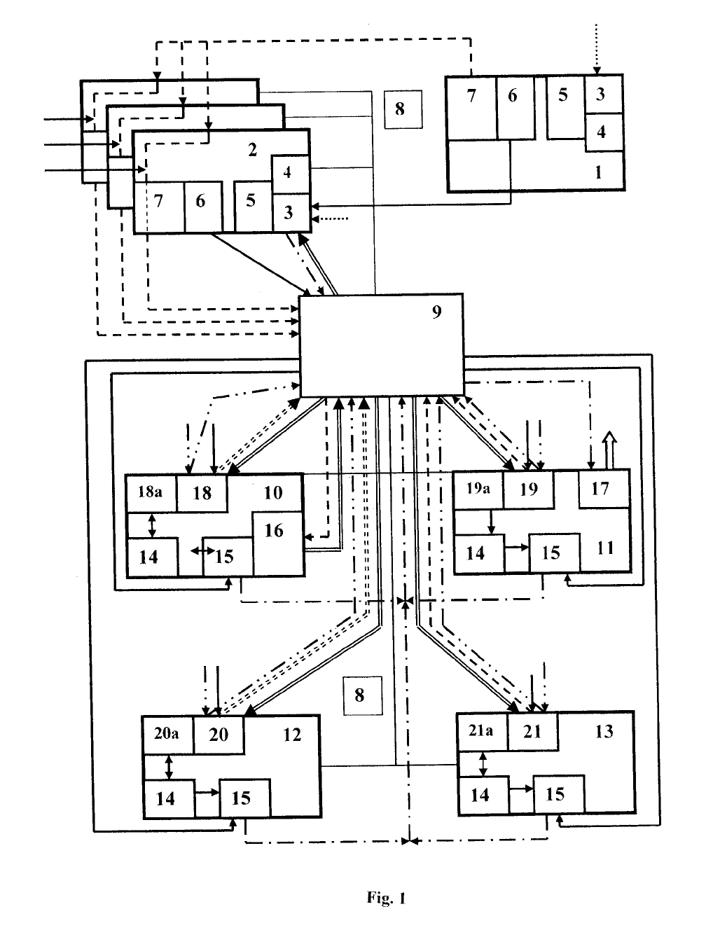

FIG. 1 illustrates one embodiment of the automated system according to the invention, in which the automated system includes a control terminal 1 of an official person, allocated, for example, at the Central Electoral Commission of the Russian Federation, terminals 2 of the official persons, for example, members of a local electoral commission at a voting precinct. The terminals 1 and 2 include operational devices 3, non-volatile memory devices 4, information display devices 5, data output devices 6 and devices 7 forming access right identification means for the official person to the voting device for performing scheduled operations and summing up the voting results, and voting subjects of will expression.

Operational devices 3 may consist of a microprocessor of any architecture, for example, a computer IBM PC with compatible input devices. The input devices may consist of well known units such as a keyboard, a mouse or a touch screen. For entry of key access codes of official persons input devices may be used for optical reading of information from a non-volatile carrier containing key codes or data entry by means of a set of given key codes from a keyboard compatible to the used computer, or a set of key codes by means of a touch screen can be used.

The non-volatile memory devices 4 may consist of well known memory devices such as non-volatile memory cards of flesh-cards.

Information display devices 5 may be any devices providing a display of entered and processed information using an appropriate interface, for example, a monitor, a graphical display, for example, a liquid-crystal display.

The data output devices 6 may be devices used for data recording, for example, on flesh-cards.

The devices 7 creating access right identification means may be used for data recording on an acceptable media generated in the form of a desirable configuration, for example, character strings in an electronic form or in the form of a bar code. Electronic memory cards, paper carriers, smart cards, magnetic cards and others may be used as carriers of identification means.

The network 8 connects a network controller 9 to terminals 10, 11, 12, 13 of the voting places and connects them to the workstation terminal 2.

The terminals 10, 11, 12, 13 of the voting places comprise non-volatile memory devices 15 and voting results processing devices, for example, in the form of a microprocessor of a well known configuration providing processing of the information by means of installed software.

In this case, one of the voting place terminals, for example, the terminal 10, shown in FIG. 1 comprises an electronic local database 16 including continuously formed access right identification means for voting, voting data blocks comprising data on the type of election and variants of given selection objects supplied by the terminal 1, as well as information on the operation schedule of the terminals including the time of access to the voting device and to the documentation devices, key access passwords. The local base 16 is used for submission of the information by request from the terminals 10, 11, 12 and 13 through a network controller.

In so doing one of the voting place terminals, for example, the terminal 11 shown in FIG. 1 may include a documentation device 17 providing continuous recording in a form suitable for subsequent visual acquaintance with the voting results arriving from all terminals 10-13 in the course of voting, and the subsequent record of the voting summary protocols. The documentation device 17 may include, for example, a printer capable of printing of the received information on a roll carrier, for example, on a paper roll.

The voting place terminals 10, 11, 12, 13 include voting devices 18, 19, 20, 21, which may be different and perform functional tasks on input of codes of the access right identification means, by comparing the entered codes with the activation codes of the database, and a selection of a desirable selection object on the basis of the entered information displayed on the devices 18a, 19a, 20a, 21a.

For example, as shown in FIG. 1, the voting device 18 comprises an input unit reading data from a carrier, for example, a paper carrier comprising codes of the access right identification means made in the form of bar codes, means for input of commands from a keyboard and a display device 18a in the form of a graphical display. The voting device 20 comprises input means reading information from a carrier, for example, from a magnetic card, an input means for entry commands from a keyboard, and a display device 20a in the form of a graphical display. The voting device 21 comprises data input means reading the data from a carrier, for example, a magnetic carrier, a part of codes of identification means given by an official person, and means reading data from a keyboard, said device 21 being capable of creation of additional codes of the access right identification means of the subject of will expression by the subject himself typing a character set from a keyboard, and a display device 21a in the form of a graphical display. The voting device 19 comprises means reading data from a touch screen, for example, a part of the code given to the subject of will expression by an official person at registration, and creation of another part of the code by a character set on a touch screen, or by selection of a unique random sequence generated by the voting device 19, or its desirable part, and a display device 19a in the form of a touch screen.

According to the invention, the voting devices may include an audio-system for a soundtrack of the data display, for example, in the form of a dialog mode. They may also include sound signal generating means to indicate an event, for example, the beginnings and end of voting of one person, an approach of access time for official persons to the voting device for drafting voting summary protocols.

FIG. 1 illustrates the information flows between the terminals of the automated system according to the invention in one embodiment of realization of the method of voting preparation and implementation according to the invention.

At the control terminal 1 an official person having the right of access confirmed by entry in the data input device 3 of the key code identifying the scope of his rights by the key code stored in the local database of the terminal 1. The operational device 3 and display device 4 generate data blocks on the basis of the information stored in the local database:

information on the type of election and the variants of selection objects submitted to the subjects of will expression on the ballot day at the voting precinct;

a list of key access codes of official persons providing an access to the process of input, recording, processing, display, saving, documenting, data transfer and drafting protocols on the voting summary at the voting precinct in a scope of rights given to the voter and;

information on the established access time given to the subjects of will expression for voting;

information on established access time to the voting device given to the official persons;

information allowing one to identify the subject who generated said data block under the key access code given to him for performing said operation;

a key code identifying the access rights of an authorized official person to the voting device by each type of election conducted at a voting place,

a list of physical persons—prospective subjects of will expression by each type of election for each voting precinct.

The generated data blocks are saved in the local database of the terminal 1 on a non-volatile memory device 4, the device 6 being used for recording on non-volatile memory cards, for example SD-cards, for transmission by means of acceptable communication facilities on voting precincts to the official person on the terminals 2 of the workstations. These operations can be performed prior to the ballot day, and the information on the types of forthcoming elections including referenda may be submitted to agitators and members of election teams and candidates for acquaintance and for starting the agitation activity prior to the ballot day. In this case, the data on the forthcoming voting may be changed, for example, by amending the variants of selection objects by excluding candidates in the election campaigns by the official person at the voting precinct having the right of performing such an operation on the basis of a key code given to him and a code of identification of the person in the identification means the right of access.

The official person of the control terminal 1 uses the device 7 to produce data for access right identification means to allow the official person to operate the automated system devices, said data comprising a voting precinct code, types of voting codes, a key code to perform the operations according to the rights given to said official person and functions and identification code of this person. Then the data are transferred to the local database of the terminal 1 and then onto a carrier, for example, a compact disc protected from unauthorized access with submission to official persons at a voting precinct by means of acceptable communication facilities.

The official person of the control terminal 1 uses the device 7 to produce data for access right identification means to allow the official person to operate the automated system devices, said data comprising a voting precinct code, types of voting codes, a key code to perform the operations according to the rights given to him and functions and identification code of this person. Then the data are sent to the local database of the terminal 1 and then onto a carrier, for example, a magnetic card, and submitted to the voting precinct. In so doing the quantity of such magnetic cards may be equal to a predicted quantity of the subjects of will expression at the voting precinct taking into account possible additions. On the other way, the quantity of such magnetic cards may be low in case of simultaneously voting of several subjects according to the quantity of voting devices.

However the access right identification means may also include access codes of each of the subjects of will expression, for example, by input of a sequence of random characters unique for each identification means generated in the device 7 of the control terminal 1 and in this case the quantity of independent carriers should is selected taking into account a predicted quantity of voting participants according to the quantity of persons in the electoral registers and their possible increase at the voting registration on the ballot day.

At the voting precinct the official person, for example, a member of a local electoral commission prior to the ballot day, for example, during the election campaign receives the carrier with voting data protected from unauthorized access and identification means for access to these data. The voting data from the carrier are fed to the computer 3 used for data read-out from the magnetic medium, and after arrival in the computer 3 of the results of reading the identification code submitted by the member of the commission he gets an access to operation at the computer 3.

Then the computer 3 is used for producing in the workstation terminal 2 a local database comprising at least data blocks by each type of elections including their codes and variants of selection objects, for example, a list of candidates for each type of election and key codes for access for official persons to the voting place terminals and to control the operating modes of the terminals. In addition, the official person produces a data block of the local database of prospective subjects of will expression comprising the received lists of prospective voting participants i.e. voters by each type of election. In the period prior to the ballot day the voting data blocks and data blocks of prospective subjects may be provided with new information which the member of the commission also introduced into the local database. Prior to the ballot day the voting data blocks may be compared with the information stored in the control terminal 1 database by request and response through acceptable communication lines.

On the ballot day or the day before regulated by the access time of the official person to the operational device to perform the operations, in the operational device 3 of the terminals 2 the verified data block is sent to the local database of the terminal 2, duplicated on non-volatile memory devices, for example, flesh-cards, for example, for archiving, and transfer through the network controller 9 or the SD type memory cards to the voting places terminals 10, 11, 12 and 13.

Received on the eve of the ballot day from the control terminal 1, the access right identification means of the subjects of will expression are securely saved by the members of the local electoral commission before coming the voting time.

After the ballot day voting time has come, the operational device 3 of the terminals 2 automatically sends a command for switching on all voting devices of the voting place terminals 3 at the voting precinct and a command for opening the voting process. This event may be accompanied by a sound signal from the voting devices that allow one to check the working capacity and readiness of the voting devices. The precinct opens for voters.

This command and the time of its reception are saved in the local databases of voting place terminals 3, and a program of automatic operation of the network controller and voting place terminals 3 is started. At the same time, the documentation device 17 starts a continuous process of voting documentation and voting results in the voting devices with printing the output in a printer on roll carrier, for example, a paper carrier. This process is carried out during the entire access time for voting of the subjects of will expression under control of devices 10, 11, 12, 13. The recording is started from information on the date and time of the beginning of documentation and on the type of election being conducted.

At the voting precinct an arrived voter is verified by the official persons—members of the local electoral commission at the workstation terminal 2 by the documents shown to them, check the correspondence of these data with the data in the electoral register of the local database, and then register the voter as a subject of will expression.

One of the voting access right identification means of a voting subject available at the precinct comprising a voting precinct code and codes of the type of elections to be conducted at the voting precinct on the ballot day are given to the registered subject. Then the subject right to vote is verified by each type of elections and the codes of types of elections in the database are activated, with respect to which the voting of the subject is considered rightful. The produced identification means may also include an access right identification code of this subject if such means has arrived from an official person from the control terminal 1.

The codes of the produced subject access right identification means may be added to the codes of identification of the voting access right of this subject, in the device 7 producing identification means in the terminal 2 or in the process of access of the subject to the voting device in the system used for such voting operations in the terminals 11 and 13. For example, in the voting device 19 used for generation of a random character string and comprising a touch screen for display of the generated sequence with a possibility of selection by the subject of its desirable part as a code. The selected code is automatically put in the base 16 of produced identification means and automatically gives to the subject and access to the information required for voting.

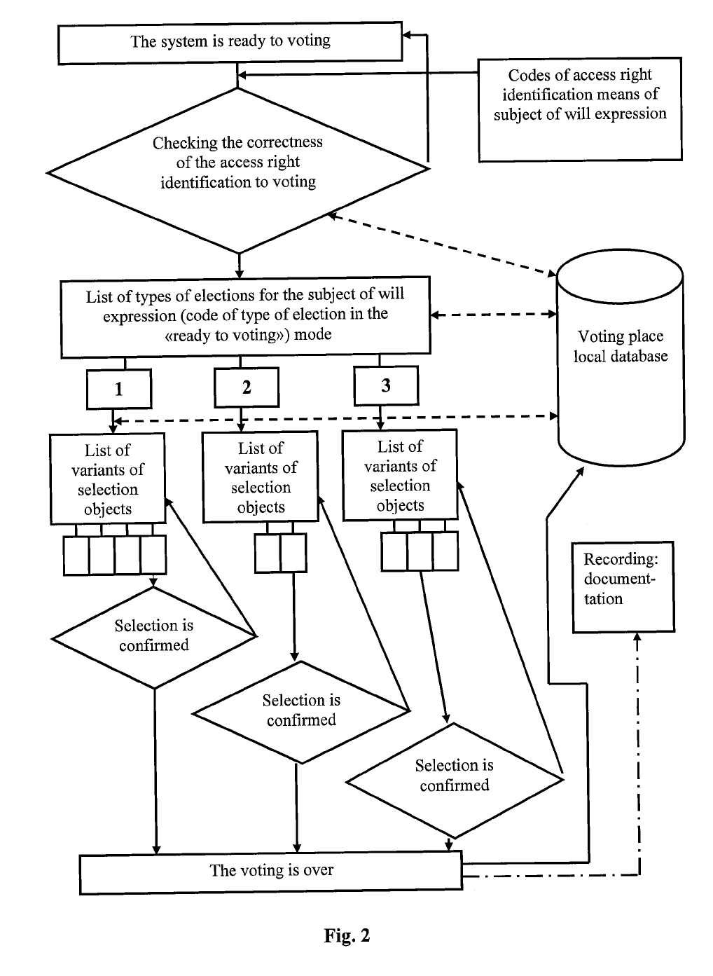

The sequence of the automated operations carried out in the voting device 19 is illustrated by the scheme in FIG. 2.

The beginning of voting in the voting device 19 being in the <<system is ready to voting>> mode is possible only after the local base 16 has obtained a complete set of codes of the access right identification means of the subject to voting.

During the voting period the access to the voting devices and voting terminals 3 is permitted only to the subjects of will expression submitting their codes of the access right identification means.

Then the device 19a displays to the subject of will expression a list of types of elections, in which this subject has the right to participate. After his selection of a type of elections in the given list, for example, by activating the code of the type of election by means of tactile contact with an appropriate area of the touch screen, the subject sees an image of the variants of selection objects, for example, in the form of a list of the registered candidates of the election campaigns or in the form of a list of questions at referendum.

The subject can choice a selection object repeatedly, coming back to the list of selection objects, until he select a desirable object whose selection is confirmed by activation of an appropriate character on the screen.

The process and result of selection of an object by the subject of will expression is automatically sent to the local database 14 and to the documentation device 17, where it is printed on a roll paper carrier.

After selection of desirable objects by all given types of elections the subject confirms the end of voting, and the voting device 19 automatically transmits the information on this event to the voting precinct local database including the local database 16 and to the documentation device 17. In so doing the device 17 provides printing of the voting results of the subject on a paper roll carrier, the voting device 19 automatically comes to the “system is ready to voting” mode, the codes of the used identification means are removed from the local base 14, and the voting results are saved in the voting precinct local database.

The beginning and end of voting made by the subject may be accompanied by a sound signal of such an event that could determine by hearing the correct actions of the subject under conditions of a terminal closed for viewing by third parties and to identify the busy voting device.

Thus, the use of repeatedly identical codes for access to the voting device is impossible, the voting result is documented on a carrier under conditions of the closed for access, and the voting device 19 is ready to a new working cycle.

The operational device 3 of the terminal 2 or data processing devices 15 of the terminals 10, 11, 12, 13, receiving the information on the end of voting of the subject performs statistical processing of the received information and produces data blocks on the voting progress by types of elections.

Described in the method for preparation and implementation of electronic voting according to the invention the method for documenting the process and results of the voting taking place at the voting precinct on one continuous carrier allows one to estimate not only the voting result but also the voting process including detection of attempts of unauthorized access to the voting device.

Therefore, the voting process and results of voting of all subjects of will expression are documented on one carrier.

After the time of access to voting is over, the processing devices 15 automatically perform statistical processing of the voting results and sent the processing results to the voting precinct local database.

When the voting devices receive a command on the end of time of access to them, the subjects of will expression of the voting device automatically come to the <<tally of votes>> mode, in which access to the voting device and to the terminals 10, 11, 12, 13 of the voting places can be effected only for a person who transfers in the voting device the identification means key code confirming the access right corresponding to the key code contained in the voting data block in the voting precinct local database. Such a code is granted to an official person authorized for such actions.

Then the authorized official person can see an image of the type of elections, respective protocol on the voting summary and the results of the statistical processing of the voting results of all processing devices 15. The protocol on the voting summary is filled, the data for which are automatically taken from the given processing results. The protocols are automatically saved in an electronic form in the voting precinct local database with index of the key of the identification access right of the official person and automatically sent by means of acceptable communication facilities to the terminal 1 of the administrator. The protocols are also automatically printed on a separate paper carrier for signing by the members of the local commission and then transferred by hierarchy to other official persons in a closed access mode. The device 17 performs documentation of the protocols by a command of the official person and also provides documents on the same roll paper carrier which is used for recording the voting process at the precinct and the voting results of all participating subjects of will expression. It is obvious that the length of the roll carrier should be sufficient for continuous recording all documented results and events, as well as the time of switching the operating modes of at least the voting devices.

Then an authorized official person takes out the roll paper carrier, packs it for archiving, and then transfers in a closed access mode to other officials according to hierarchy.

FIG. 1 schematically illustrates the information flows including the following: 22 is an input of a key code of the official person of the terminal 1; 23 is the access right identification means transferred from the terminal 1 to the terminal 2; 24 is the voter's call, 24a is an identification means of the subject of will expression access right to the types of voting; 25 is an identification means of the subject of will expression prepared in the terminal 2; 26 is identification means providing access right for voting prepared by the subject of will independently in the voting device, 26a is data transfer to the database 16 through a server 9, 26c are responses of the database 16 to requests of the terminals 2, 10, 11, 12, 13; 27 is a call of official persons, 27a is access right identification means of the official persons, 27c is transfer of data to the database 16 through the server 9; 28 is transfer of data on the voting progress and the voting results and on the voting summary protocols.

On the basis of the above description of an embodiment of realization of the method for preparation and implementation of electronic voting according to the invention by means of an automated system according to the invention in the field of information technologies and computer engineering it should be obvious to those skilled in the art that improvements may be made in the described method and system according to the invention without departing from the spirit and scope of the invention. For example, the voting terminals may be capable of performing offline operation in a different configuration convenient for transportation, for a soundtrack of the subject in the voting progress, various units in the system terminals providing attainment of the above said functional tasks.

1. A method for preparation and implementation of electronic voting by means of electronic devices for input, output, record, processing, display, saving, printing, documenting, reception and data sent and voting devices including following operations:
development by an official person of a voting data block comprising at least:
information on a type of elections and variants of selection objects submitted to the subjects of will expression on the ballot day at the voting precinct;
a list of key access codes for official persons to the process of input, recording, processing, display, saving, documentation, data transmission and drafting protocols on the voting summary at the voting precinct in a scope of rights given to him and;
information on established access time given to the subjects of will expression for voting;
information on established access time to the voting device given to the official persons;
information allowing one to identify the subject who has generated said data block under the key access code given to him for performing said operation;
a key code identifying the access rights of an authorized official person to the voting device by each election conducted at a voting place,
saving the generated voting data block;
writing lists of physical persons—prospective subjects of will expression by each type of election for each voting precinct;
submission of said voting data block and said lists of physical persons to a forthcoming voting precinct;
development of access right identification means for the official person at the voting precinct, submission of said identification means to said authorized official person;
development of access right identification means of each prospective subject of will expression at voting by type of elections comprising at least codes identifying the voting precinct, types of elections and a identification code providing access of the subject of will expression at voting;
development of said access right identification means in an amount sufficient for identification of the voting access right for each of the supposed amount of prospective subjects of will expression on the ballot day at the voting precinct;
transmission of said plurality of access right identification means of the subjects of will expression to a respective place of the forthcoming voting in a restricted access mode;
development of the voting precinct local database comprising said lists of physical persons—prospective subjects of will expression and said voting data block, said database being used by the official person whose scope of rights is confirmed by his presentation of the key code of the access right identification means corresponding to the key code stored in said voting data block;
checking the correspondence of identification data given by the physical person with the data in said list of persons stored in the voting precinct local database; registration of said physical person as a subject of will expression at the voting precinct;
submission to the subject of will expression of the access right identification means for voting comprising at least codes identifying the voting precinct and the types of elections to be conducted at the voting precinct on the ballot day;
checking the competence of the subject of will expression to take part in the voting according to the type of election whose code comprises in the access right identification means given to him;
exclusion by the official person of the subject of will expression from the access right identification means whose code of the type of election in which the subject of will expression has no right to participate;
development by an official person at a voting precinct of a local database with access right identification means given to the subjects of will expression by entering and saving the digital data contained in said identification means;
activation by the official person in said local database of codes of the type of elections, the access to which of the subject of will expression is recognized competent by transferring such codes to the <<ready for voting>> mode;
allowing the subject of will expression to input the codes stored in the access right identification means given to him into the voting device under conditions of observance of voting secrecy;
in the automatic mode under conditions of locking the access for any person but the subject of will expression, within a preset access time given to the subjects of will expression for voting:
checking the correspondence of the codes entered by said subject of will expression in the voting device with the codes activated in said local database in a <<ready for voting>> mode;
submission to said subject of will expression of display of the voting information comprising:
a list of type of elections, in which appropriate codes are activated for in the local database for said subject;
information on the selected type of the elections saved in the voting precinct local database;
variants of selection objects in the type of elections selected by the subject of will expression;
a proposal to the subject of will expression on each of the selection objects selected by him to confirm the made selection or to refuse it, to return to the beginning of voting and to make selection again;
transfer by the subject of will expression who finished the voting on the type of election to the <<voting is completed>> mode;
in the automatic mode under conditions of locking the access for any person;
removal from the local database of the codes of the access right identification means of the subject of will expression who completed the voting;
continuous saving in the voting precinct local database of the voting results of the subjects of will expression at the voting precinct and simultaneous continuous documentation of the voting process in a form suitable for visual acquaintance;
termination of the saving and documentation of the voting results after a preset time of access given to the subjects of will expression for voting;
statistical processing of the voting results saved in the voting precinct local database according to legislatively established parameters of forms of protocols on the voting summary by each voting type, saving the processing results in the voting precinct local database;
display of a notice on approach of the time of access of the official persons to the voting device;
in the automatic mode under conditions of locking the access for any person but the official person who has confirmed his right of access input in the voting device of the access right identification means for the official person comprising a key code identical to the key code saved in the voting precinct local database:
displaying the established forms of protocols on the voting summary by each type of elections and the results of the statistical processing of the voting results stored in the local database;
filling the displayed forms of protocols with the indication of a key code of the official person in the protocol;
saving the protocols in a digital form in the local database,
submission to the official person of the voting summary protocols recorded on a non-volatile carrier suitable for visual observation and fir sighing the protocols;
documentation in a form suitable for visual acquaintance of the protocols on the voting summary on a carrier comprising the documented results of earlier voting of all subjects of will expression at the voting precinct;
displaying the transfer of the voting device to the <<election campaign is completed>> mode;
providing a possibility of removal from the device of the non-volatile carrier comprising the documentary information on continuous recording the voting results of all and each of the subjects of will expression and the voting summary protocols, archiving them in a form providing its safety and inaccessibility for unauthorized access or its removal from the device.

2. The method according to claim 1, characterized in that the subject of will expression has access right identification means selected in a random way from a set of such identification means submitted to the voting precinct from an official person and not used for access to the voting till the moment of registration of this subject of will expression.

3. The method according to claim 1, characterized in that the subject of will expression has access right identification means comprising codes identifying the voting precinct and the types of elections conducted on the ballot day at the voting precinct, and the identification code providing access of the subject of will expression to voting is produced by the official person directly at the voting precinct.

4. The method according to claim 1, characterized in that the subject of will expression has access right identification means comprising codes identifying the voting precinct and the types of elections conducted on the ballot day at the voting precinct, and the identification code providing access of the subject of will expression to voting is produced independently by the subject of will expression directly in the voting device.

5. The method according to claim 1, characterized in that the access right identification code of the subject of will expression comprises a unique random character string.

6. The method according to claim 1, characterized in that place each access right identification means is formed on an acceptable carrier with a possibility of read out and recognition.

7. The method according to claim 1, characterized in that the access right identification means is placed on a carrier selected from the group including a smart card, a paper carrier, a plastic carrier, a magnetic medium.

8. The method according to claim 1, characterized in that the codes of the access right identification means placed on an acceptable carrier in the form of a bar code.

9. The method according to claim 1, characterized in that the continuous documentation of the voting results and protocols on the voting summary is effected at the voting precinct by printing a continuous image on a carrier having a size sufficient for writing thereon all said results and protocols.

10. The method according to claim 9, characterized in that continuous printing is effected on a roll of a paper carrier.

11. An automated system for realization of the method for preparation and implementation of electronic voting according to any claim of 1 to 10 including:
an official person control terminal and at least one an official person workstation at the voting precinct interconnected through acceptable communication facilities and comprising at least the following devices:
an operating device of the terminal used for data input, reception, recording, processing, creation of data blocks and local databases comprising:
information on the types of elections conducted at voting precincts on variants of selection objects,
a list of key codes and a scope of the access rights of the official persons at said terminals,
data on access right identification means given to the subjects of will expression at the voting precinct,
installed modes of access to said terminals and access given to the subjects of will expression for voting,
operating conditions of said terminals,
lists of prospective subjects of will expression, who will vote at each election voting precinct,
a non-volatile memory device;
a display device used for visualization of the information sent to the local databases and taken therefrom in a graphical, tabular and/or text form using a type of selection interface;
a data output device used for transmission of data blocks to the voting precinct database and their recording on a non-volatile carrier;
a device for creating access right identification means for the official person to the voting device or the subject of will expression for voting at any type of election comprising codes of identification of the access right concerning the information from the voting precinct local database with a possibility for input of these codes in the voting device, and creations of a local database of the access right codes pf the identification means given to the subjects of will expression;
and in so doing the official person workstation at the voting precinct is protected from access of any person but the official person who makes a call to the terminal while submitting the key access code identifying him in a scope of rights given to him and identical to the key access code stored in the voting precinct local database;
voting place terminals connected to each other and to the official person workstation at the voting precinct through a network controller comprising:
a voting device with a display means,
a device for processing the voting results,
a memory device, and in so doing:
at least one of the voting place terminals at the voting precinct includes a device for documenting the voting process and results including the voting summary protocols,
a workstation terminal of the official person and voting place terminals connected to the network controller and providing functioning of the local databases in a continuous mode with a possibility of introducing by the authorized official person restrictions of the access rights of the subject of will expression concerning the information from the voting precinct local databases, and
the voting place terminals are used for performing the following operations:
in the automatic mode under conditions of blocking the access to the voting place terminal devices for any person but the subject of will expression within a preset access time:
input in the voting device of codes of the identification means presented by the subject;
connection of the access right identification means to the local database in an interrogation mode and checking the identity of the entered codes with the codes stored in the database of given access right identification means of the subjects of will expression or the official person;
display for the subject of will expression with the help of a device for visualization of the information including the interface of the type of elections and variants of selection objects, said subject being capable of controlling the image of the selected object for subsequent registration of the result of his primary or repeated voting,
transfer of the type of election code, on which the voting is completed to the <<voting is completed>> mode,
in the automatic mode under conditions of locking the access for any person:
removal from the local database of the codes of the access right identification means of the subject who completed the voting;
saving the voting results of the subject of will expression in the voting precinct local database;
continuous saving of the voting results of the subjects of will expression in the local database and continuous documentation of the voting process and the voting results on a non-volatile carrier suitable for visual acquaintance,
termination of saving and documentation of the voting results after a preset time of access given to the subjects of will expression for voting;
statistical processing of the voting results stored in the local database according to the legislatively established parameters of forms of protocols on the voting summary for each of type of voting, saving the processing results in the voting precinct local database;
displaying in the voting device an image of a notice on approach of the time of access of the official persons to the voting device;
in the automatic mode under conditions of blocking the access to the voting place terminal for any person but the official person after the time for such an access:
input of the codes of the access right identification means in the official person voting device;
connection of the access right identification means to the local database in an interrogation mode for checking the identity of the entered codes to the codes stored in the local database with access right identification means of the official person;
displaying the forms of protocols on the voting summary by each type of elections and the results of the statistical processing of the voting results which are stored in the local database;
providing a possibility of filling the displayed forms of protocols, signing the protocols with indication of a key code of the official person in the protocol;
saving the signed protocols in a digital form in the local database,
submission to the official person of the original of protocols on the voting summary on an acceptable non-volatile carrier,
documentation of protocols on the voting summary on a non-volatile carrier comprising earlier documented results of voting of all subjects of will expression at the voting precinct in a form suitable for visual acquaintance,
display of the transfer of the voting device to the <<election campaign is completed>> mode,
providing a possibility of removal from the device of the non-volatile carrier comprising continuous recording of an image of the documentary information on the voting results of all and each of the subjects of will expression and the voting summary protocols, their signing and archiving in a form providing its safety and inaccessibility for unauthorized access or its removal from the device.

12. The system according to claim 11, characterized in that the device for creating access right identification means is used for generation of a code in the form of a unique random character string and its recording on the carrier of the access right identification means given to the subject.

13. The system according to claim 11, characterized in that, the device for creating access right identification means is used for allocation of each access right identification means on a non-volatile carrier with a possibility of read out.

14. The system according to claim 11, characterized in that the device for creating access right identification means is used for allocation of said means on a carrier from the group including a smart card, a paper carrier, a plastic carrier, a magnetic medium.

15. The system according to claim 11, characterized in that the device for creating access right identification means is used for disposing the codes of said means on an acceptable carrier in the form of a bar code.

16. The system according to claim 11, characterized in that the voting device is used for input of the codes of the access right identification means by reading.

17. The system according to claim 11, characterized in that the device for creating access right identification means is used for creating means comprising codes identifying the voting precinct and the types of elections conducted on the ballot day at the voting precinct, and the voting device is used for producing a code identifying the right of access of the subject of will expression to the voting by input in the voting device of desirable characters and their saving in the voting precinct local database.

18. The system according to claim 16, characterized in that the voting device is used for generation of a code in the form of a unique random character string and submission to the subject of will expression of such a sequence or his desirable part by his choice as a identification code of the subject of will expression having the access right for voting.

19. The system according to claim 11, characterized in that the voting device is equipped with means generating a sound signal at the beginning of voting of the subject of will expression and at the end of his voting.

20. The system according to claim 11, characterized in that the voting place terminal has an audio system for generating sound signals.

21. The system according to claim 11, characterized in that the documentation device is used for continuous documentation of the voting results including the voting summary protocols by way of continuous printing the data fed in the device on a carrier having a size sufficient for writing thereon all said results and protocols.

22. The system according to claim 11, characterized in that the documentation device is used for continuous printing the data on a roll of a paper carrier.

23. The system according to claim 11, characterized in that system terminals are used for transferring data and documents by means of acceptable switching and communication facilities.

24. The system according to claim 11, characterized in that the voting device comprises:
an input device reading information from non-volatile memory cards by means of a card reader,
an information output and display unit,
a device for input of access codes reading the data the codes from a carrier of access right identification means and/or a device for input of access codes from a keyboard and/or a device for input of access codes by tactile contact with characters placed on a touch screen and/or by means of saving in memory of a unique random character string generated in the voting device or its desirable part by choice of the subject of will expression.

25. The system according to claim 11, characterized in that the voting place terminal is portable and adapted for offline work and transportation and has an independent power supply and a documentation device in the form of a printer used for printing on a continuous carrier.
